(19) United States
(12) Patent Application Publication
(10) Pub. No.: US 2025/0046848 A1
(43) Pub. Date: Feb. 6, 2025

(54) AIR-COOLED FUEL CELL SYSTEM

(71) Applicant: TOYOTA JIDOSHA KABUSHIKI KAISHA, Toyota-shi (JP)

(72) Inventor: Nobuaki NONOYAMA, Chiryu-shi (JP)

(73) Assignee: TOYOTA JIDOSHA KABUSHIKI KAISHA, Toyota-shi (JP)

(21) Appl. No.: 18/786,935

(22) Filed: Jul. 29, 2024

(30) Foreign Application Priority Data
Jul. 31, 2023 (JP) 2023-124076

(51) Int. Cl. H01M 8/2475; H01M 8/04007; H01M 8/04014; H01M 8/04223; H01M 8/04746

(52) U.S. Cl. CPC H01M 8/2475; H01M 8/04014; H01M 8/04067; H01M 8/04231; H01M 8/04753; H01M 8/04768

(57) ABSTRACT

To provide a fuel cell system capable of suppressing generation of dew condensation and freezing of valves and pipes. An air-cooled fuel cell system, wherein the fuel cell system comprises a fuel cell, a hydrogen system for supplying hydrogen to the fuel cell, a reaction air system for supplying reaction air to the fuel cell, and a cooling air system for supplying cooling air to the fuel cell; wherein the fuel cell comprises a reaction air flow path and a cooling air flow path and has a flow path structure in which the reaction air and the cooling air are independent.

### CROSS-REFERENCE

This application claims priority to Japanese Patent Application No. 2023-124076 filed on Jul. 31, 2023, incorporated herein by reference in its entirety.

### TECHNICAL FIELD

The present disclosure relates to an air-cooled fuel cell system.

### BACKGROUND

Various studies have been proposed for fuel cells (FC) as disclosed in Patent Documents 1 to 4.
Patent Document 1: Japanese Patent Application Laid-Open (JP-A) No. 2022-185248
Patent Document 2: JP-A No. 2006-209994
Patent Document 3: JP-A No. 2022-185251
Patent Document 4: JP-A No. 2022-185247

In the prior art, the temperature control of the reaction air system and the hydrogen system is not taken into consideration, and there is a possibility that when the environmental temperature of a fuel cell system is low, freezing occurs in the valves and pipes due to the generation of dew condensation during the shutdown of the fuel cell system. To suppress the condensation, an additional configuration for condensation suppression is required, and an increase in the size of the fuel cell system is inevitable.

### SUMMARY

The disclosure was achieved in light of the above circumstances. An object of the disclosure is to provide an air-cooled fuel cell suppressing the occurrence of condensation and freezing in the valves and pipes.

In the first embodiment of the present disclosure, there is provided an air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the hydrogen system comprises a circulation system for circulating the hydrogen supplied to the fuel cell;
wherein the fuel cell system comprises a case;
wherein the case houses the fuel cell;
wherein the case includes, with respect to the fuel cell, an upstream space and a downstream space in the flow direction of the cooling air in the case; and
wherein the circulation system of the hydrogen system is disposed in the downstream space.

In the second embodiment of the present disclosure, there is provided an air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the hydrogen system comprises a hydrogen purge valve at an outlet for the hydrogen of the fuel cell;
wherein the fuel cell system comprises a case;
wherein the case houses the fuel cell;
wherein the case includes, with respect to the fuel cell, an upstream space and a downstream space in the flow direction of the cooling air in the case; and
wherein the hydrogen purge valve of the hydrogen system is disposed in the downstream space.

In the third embodiment of the present disclosure, there is provided an air-cooled fuel cell system, wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the reaction air system comprises an inlet-side sealing valve at an inlet for the reaction air of the fuel cell and an outlet-side sealing valve at an outlet for the reaction air of the fuel cell;
wherein the fuel cell system comprises a case;
wherein the case houses the fuel cell;
wherein the case includes, with respect to the fuel cell, an upstream space and a downstream space in the flow direction of the cooling air in the case; and
wherein at least the outlet-side sealing valve of the reaction air system is disposed in the downstream space.

According to the fourth embodiment of the present disclosure, in the first embodiment, the hydrogen system may comprise the circulation system and a hydrogen purge valve at an outlet for the hydrogen of the fuel cell, and the circulation system and the hydrogen purge valve of the hydrogen system may be disposed in the downstream space.

According to the fifth embodiment of the present disclosure, in the first embodiment, the hydrogen system may comprise the circulation system and a hydrogen purge valve at an outlet for the hydrogen of the fuel cell;
the reaction air system may comprise an inlet-side sealing valve at an inlet for the reaction air of the fuel cell and an outlet-side sealing valve at an outlet for the reaction air of the fuel cell; and
the circulation system of the hydrogen system, the hydrogen purge valve thereof, and at least the outlet-side sealing valve of the reaction air system may be disposed in the downstream space.

The present disclosure can suppress the occurrence of dew condensation and freezing in the valves and pipes.

### BRIEF DESCRIPTION OF THE DRAWINGS

In the accompanying drawings,

FIG. 1 is a schematic exploded perspective view showing an example of a unit cell of the fuel cell included in the fuel cell system of the present disclosure;

FIG. 2 is a schematic perspective view showing an example of a fuel cell stack included in the fuel cell system of the present disclosure;

FIG. 3A is a system configuration diagram showing an example of the fuel cell system of the present disclosure;

FIG. 3B is a system configuration diagram showing an example of a conventional fuel cell system;

FIG. 4A is a system configuration diagram showing another example of the fuel cell system of the present disclosure; and

FIG. 4B is a system configuration diagram showing another example of a conventional fuel cell system.

### DETAILED DESCRIPTION

Hereinafter, the embodiments of the present disclosure will be described in detail. Matters that are required to implement the present disclosure (such as common a fuel cell system structures and production processes not characterizing the present disclosure) other than those specifically referred to in the Specification, may be understood as design matters for a person skilled in the art based on conventional techniques in the art. The present disclosure can be implemented based on the contents disclosed in the Specification and common technical knowledge in the art.

In addition, dimensional relationships (length, width, thickness, and the like) in the drawings do not reflect actual dimensional relationships.

In the present disclosure, the gas supplied to the anode of the fuel cell is a fuel gas (anode gas), and the gas supplied to the cathode of the fuel cell is an oxidant gas (cathode gas). The fuel gas is a gas mainly containing hydrogen, and may be hydrogen. The oxidizing gas is a gas containing oxygen, and may be oxygen, air, or the like. In the present disclosure, air as an oxidant gas is referred to as reaction air, and air as a cooling gas is referred to as cooling air.

In the present disclosure, there is provided an air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the hydrogen system comprises a circulation system for circulating the hydrogen supplied to the fuel cell;
wherein the fuel cell system comprises a case;
wherein the case houses the fuel cell;
wherein the case includes, with respect to the fuel cell, an upstream space and a downstream space in the flow direction of the cooling air in the case; and
wherein the circulation system of the hydrogen system is disposed in the downstream space.

In order to prevent dew condensation and water clogging in a supply device such as a valve, when a heater is installed and heated, problems arise such as an increase in size of a case, an increase in device cost, and an increase in power consumption. According to the present disclosure, by disposing a supply device such as a valve in the downstream space in the case of the air-cooled fuel cell system, the temperature of the cooling air in the downstream space in the case is high, so that condensation, water clogging, subsequent freezing, and the like are suppressed. For example, in order to suppress dew condensation and water clogging in the hydrogen system, by disposing the pipe after gas-liquid separation and the hydrogen pump of the circulation system in the downstream space, it is possible to suppress the dew condensation by warming these by the cooling air having a high temperature and raising them higher than the hydrogen exhaust temperature of the fuel cell.

The fuel cell system includes a fuel cell in which hydrogen and air react to generate power, a hydrogen system in which hydrogen necessary for power generation of the fuel cell is supplied to the fuel cell, a reaction air system in which reaction air is supplied to the fuel cell, and a cooling air system in which cooling air for cooling heat generated by power generation is supplied to the fuel cell.

The fuel cell may have only one unit cell of the fuel cell, or may be a fuel cell stack which is a stack in which a plurality of unit cells are stacked.

In the present disclosure, both the unit cell and the fuel cell stack may be referred to as a fuel cell.

The number of stacked unit cells in the fuel cell stack is not particularly limited, and may be, for example, 2 to several hundred.

The fuel cell stack may have corrugated cooling fins that serve as the cooling air flow path in each unit cell.

The fuel cell stack may include a current collector plate, a pressure plate, and the like at an end portion in the stacking direction.

The unit cell of the fuel cell may have a reaction air flow path (oxidant gas flow path) and a cooling air flow path (cooling gas flow path) having a flow path structure in which the reaction air and the cooling air are independent, and may further have a hydrogen gas flow path (fuel gas flow path).

The flow path structure in which the reaction air and the cooling air are independent means that there is no sharing of air between the flow paths from the supply of air to the fuel cell to the discharge of air from the fuel cell. The flow path for discharging the air discharged from the fuel cell to the outside of the fuel cell system may be independent or may not be independent.

The unit cell may have a flow path structure for flowing the reaction air and the cooling air so that the flow of the cooling air and the flow of the reaction air intersect each other in a plan view. The flow of cooling air and the flow of reaction air may intersect or be orthogonal.

The unit cell may include a power generation unit.

The shape of the power generation unit may be a rectangular shape in a plan view.

The power generation unit may be a membrane electrode assembly (MEA) including an electrolyte membrane and two electrodes.

The electrolyte membrane may be a solid polymer electrolyte membrane. Examples of the solid polymer electrolyte membrane include a fluorine-based electrolyte membrane such as a thin film of perfluorosulfonic acid containing moisture, and a hydrocarbon-based electrolyte membrane. The electrolyte membrane may be, for example, a Nafion membrane (manufactured by DuPont).

The two electrodes are an anode (fuel electrode or hydrogen electrode) and a cathode (oxygen electrode or air electrode).

The electrode includes a catalytic layer, and may optionally include a gas diffusion layer, and the power generation unit may be a membrane electrode gas diffusion layer assembly (MEGA).

The catalyst layer may include a catalyst, and the catalyst may include a catalyst metal that promotes an electrochemical reaction, an electrolyte having proton conductivity, a support having electron conductivity, and the like.

As the catalytic metal, for example, platinum (Pt) and an alloy composed of Pt and another metal (for example, a Pt alloy obtained by mixing cobalt, nickel, and the like) can be used. The catalyst metal used as the cathode catalyst and the catalyst metal used as the anode catalyst may be the same or different.

The electrolyte may be a fluorine-based resin or the like. As the fluorine-based resin, for example, a Nafion solution or the like may be used.

The catalyst metal may be supported on a support, and in each of the catalyst layers, a support (catalyst-supported support) on which the catalyst metal is supported and an electrolyte may be mixed.

Examples of the support for supporting the catalyst metal include carbon materials such as carbon, which are generally commercially available.

The gas diffusion layer may be a conductive member or the like having pores.

Examples of the conductive member include a carbon porous body such as carbon cloth and carbon paper, and a metal porous member such as a metal mesh and a metal foam.

The unit cell of the fuel cell may include a separator.

The separator collects current generated by power generation and functions as a partition wall. In a unit cell of a fuel cell, the separator is usually disposed on both sides of the power generation unit in the stacking direction so that a pair of separators sandwich the power generation unit. One of the pair of separators is an anode separator and the other is a cathode separator.

The anode separator may have a groove that serves as a hydrogen gas flow path on a surface on the side of the power generation unit, and may have a groove that serves as a cooling air flow path on a surface on the side opposite to the power generation unit.

The cathode separator may have a groove that serves as a reaction air flow path on a surface on the side of the power generation unit, and may have a groove that serves as a cooling air flow path on a surface on the side opposite to the power generation unit.

The separator may have holes constituting a manifold such as a supply hole and a discharge hole for allowing fluid to flow in the stacking direction of the unit cells.

The separator may be, for example, dense carbon obtained by compressing carbon to make it impermeable to gas, and press-formed metal (for example, iron, titanium, stainless steel, and the like).

The unit cell may include an insulating resin frame disposed on the outer side (outer periphery) in the surface direction of the membrane electrode assembly between the anode separator and the cathode separator. The resin frame is formed to have a plate shape and a frame shape by using a thermoplastic resin, and seals between the anode separator and the cathode separator in a condition where the membrane electrode assembly is held in a central region thereof. As the resin frame, for example, a resin such as PE, PP, PET, PEN can be used. The resin frame may be a three-layer sheet composed of three layers in which an adhesive layer is disposed on a surface layer.

The fuel cell system may include a control device. The control device may control the entire fuel cell system by controlling the reaction air system, the hydrogen system, the cooling air system, and the like.

The control device physically includes, for example, an arithmetic processing unit such as a CPU (central processing unit), a ROM (read-only memory) that stores control programs and control data to be processed by CPU, a storage device such as a RAM (random access memory) that is mainly used as various working areas for the control processing, and an input/output interface, and may be a ECU (electronic control unit).

The hydrogen system supplies hydrogen as a fuel gas to the fuel cell and adjusts the flow rate of the hydrogen. The hydrogen system may have a circulation system that circulates hydrogen supplied to the fuel cell. The hydrogen system includes a hydrogen tank, a hydrogen inlet valve, an injector, a hydrogen purge valve, a hydrogen pipe, and the like, and the hydrogen system may include, as a circulation system, a gas-liquid separator, a hydrogen pump, an ejector, a hydrogen circulation pipe, and the like. The hydrogen circulation pipe connects a gas-liquid separator, a hydrogen pump, or an ejector in this order from the hydrogen outlet of the fuel cell to the hydrogen inlet of the fuel cell, and enables hydrogen circulation.

The reaction air system supplies reaction air as an oxidant gas to the fuel cell and regulates a flow rate of the reaction air.

The reaction air system may have an inlet-side sealing valve at the inlet of the reaction air of the fuel cell and an outlet-side sealing valve at the outlet of the reaction air of the fuel cell. The inlet-side sealing valve and the outlet-side sealing valve may be disposed in an upstream space in the case or may be disposed in a downstream space in the case.

In the present disclosure, the fuel cell has a flow path structure in which the reaction air and the cooling air are independent from each other, and in the reaction air system, a valve (an inlet-side sealing valve and an outlet-side sealing valve) is installed at the inlet and outlet of the reaction air of the fuel cell, so that the fuel cell can seal the cathode of the fuel cell with a smaller volume as compared with a case where the reaction air and the cooling air have a common flow path structure.

The reaction air system may have a reaction air inlet and a reaction air blowing device. A pressure loss body (air filter) may be installed in the reaction air intake port.

The reaction air blowing device may be an air compressor, an air pump, an air blower, an air fan, or the like.

The cooling air system supplies cooling air as a cooling gas to the fuel cell and regulates a flow rate of the cooling air.

The cooling air system may comprise cooling air blowing device for generating a flow of cooling air. The cooling air system has an intake port for taking air from the outside. A pressure-loss body (air filter) may be provided at the intake port.

The cooling air blowing device may be an air compressor, an air pump, an air blower, an air fan, or the like.

The fuel cell system includes a case.

The case houses the fuel cell.

The case has an upstream space, which is an intake side, and a downstream space, which is an exhaust side, in a flow direction of the cooling air in the case with respect to the fuel cell. The case has an intake port and an exhaust port of the cooling air system.

The upstream space is a space partitioned from the intake port to the fuel cell, and the downstream space is a space partitioned from the fuel cell to the cooling air blowing device.

In the first embodiment, the circulation system of the hydrogen system is arranged in the downstream space. In the first embodiment, the reaction air system may or may not have an inlet-side sealing valve and an outlet-side sealing valve.

In the second embodiment, a hydrogen-based hydrogen purge valve is disposed in the downstream space. In the second embodiment, the hydrogen system may or may not have a circulation system. In the second embodiment, the reaction air system may or may not have an inlet-side sealing valve and an outlet-side sealing valve.

In the third embodiment, at least the outlet-side sealing valve in the reaction air system may be disposed in the downstream space, and both the inlet-side sealing valve and the outlet-side sealing valve may be disposed in the downstream space. In the third embodiment, the hydrogen system may or may not have a circulation system.

In the fourth embodiment, the circulation system of the hydrogen system and the hydrogen purge valve are disposed in the downstream space. In the fourth embodiment, the reaction air system may or may not have an inlet-side sealing valve and an outlet-side sealing valve.

In the fifth embodiment, at least the outlet side sealing valve in the circulation system of the hydrogen system, the hydrogen purge valve, and the reaction air system may be disposed in the downstream side space, and the circulation system of the hydrogen system, the hydrogen purge valve, and the outlet side sealing valve of the reaction air system may be disposed in the downstream side space, and the circulation system of the hydrogen system, the hydrogen purge valve, and the inlet side sealing valve and the outlet side sealing valve of the reaction air system may be disposed in the downstream side space.

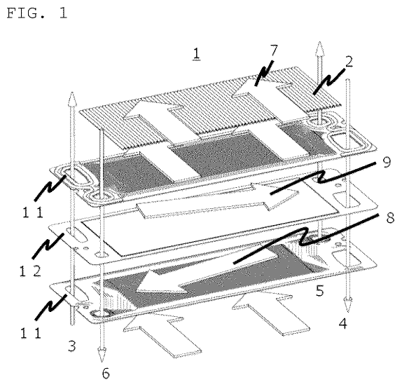

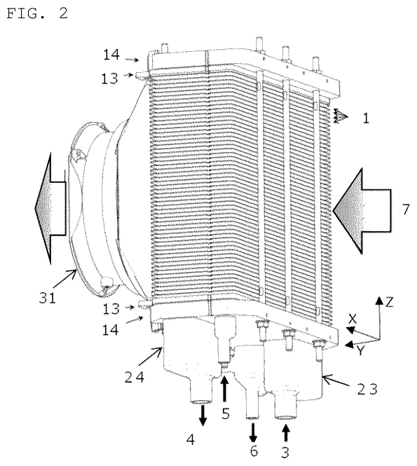

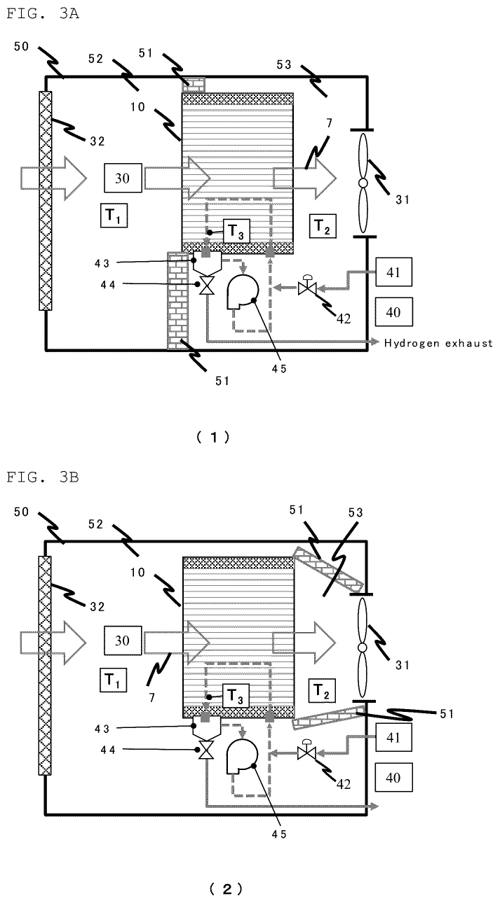

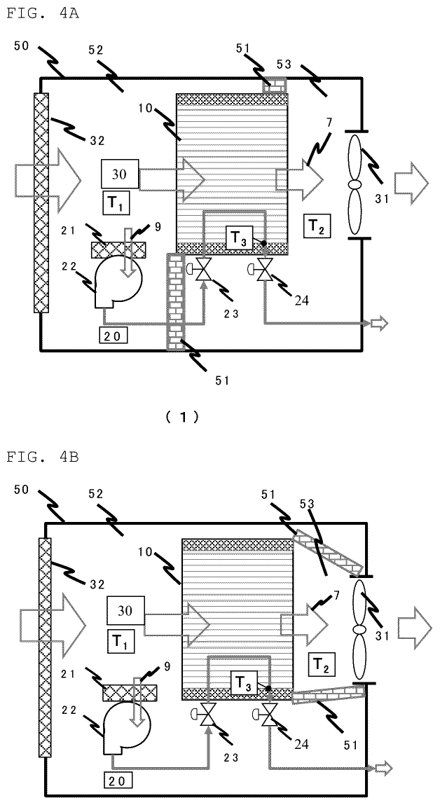

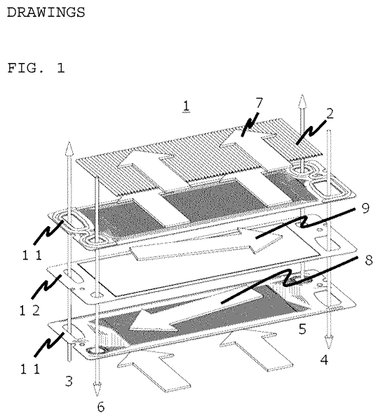

FIG. 1 is a schematic exploded perspective view showing an example of a unit cell of the fuel cell included in the fuel cell system of the present disclosure.

The unit cell 1 shown in FIG. 1 includes a cooling fin (cooling air flow path) 2 serving as a flow path for cooling air (cooling gas) 7, a reaction air inlet 3, a reaction air outlet 4, a hydrogen gas inlet 5, a hydrogen gas outlet 6, two separators 11, a MEA sandwiched between the two separators 11, and a resin frame 12. As shown in FIG. 1, the unit cell 1 of the fuel cell has a flow path structure in which the reaction air 9 and the cooling air 7 are independent from each other.

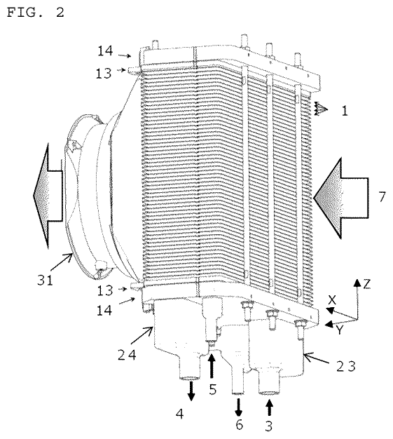

FIG. 2 is a schematic perspective view showing an example of a fuel cell stack included in the fuel cell system of the present disclosure.

The fuel cell stack shown in FIG. 2 is a stacked body in which a plurality of unit cells 1 are stacked, and includes a current collector plate 13 and a pressure plate 14 at both ends in the stacking direction.

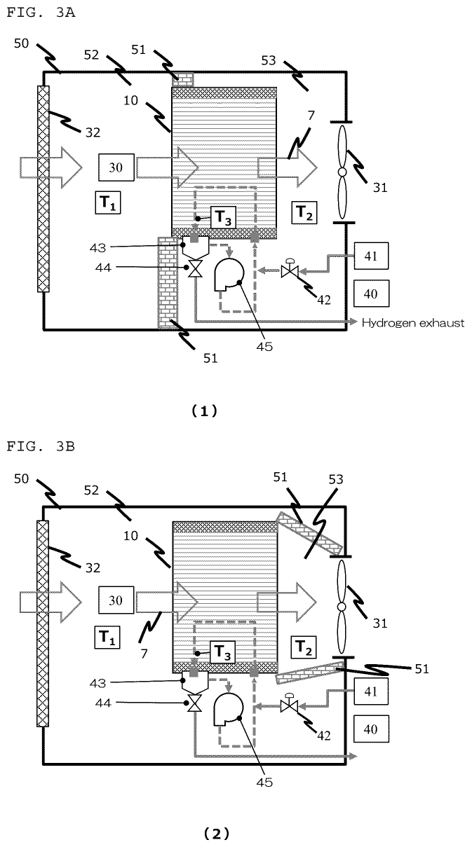

FIG. 3A is a system configuration diagram showing an example of the fuel cell system of the present disclosure, and FIG. 3B is a system configuration diagram showing an example of a conventional fuel cell system.

The fuel cell system shown in FIG. 3A and FIG. 3B include a case 50, a fuel cell stack 10, a reaction air system 20, a cooling air system 30, and a hydrogen system 40. In FIG. 3, the description of the reaction air system 20 is omitted for convenience. The cooling air system 30 includes a cooling fan 31 and an intake port 32. The hydrogen system 40 includes a hydrogen tank 41, a hydrogen inlet valve 42, a gas-liquid separator 43, a hydrogen purge valve 44, and a hydrogen pump 45. The intake port 32 may include an intake filter.

The case 50 has an upstream space 52 and a downstream space 53 partitioned by the partition walls 51 in the flow direction of the cooling air 7 in the case 50 with respect to the fuel cell stack 10. The upstream space 52 is a space partitioned from the intake port 32 to the fuel cell stack 10, and the downstream space 53 is a space partitioned from the fuel cell stack 10 to the cooling fan 31.

In the fuel cell system shown in FIG. 3A, a hydrogen inlet valve 42 of a hydrogen system, a hydrogen purge valve 44, a gas-liquid separator 43 of a circulation system, a hydrogen pump 45, and a pipe including a hydrogen circulation pipe indicated by a dotted line are accommodated in a space 53 on the downstream side of the cooling air.

Accordingly, the hydrogen outlet temperature T3 of the fuel cell stack 10 is lower than the mean temperature T2 of the cooling-air outlet of the fuel cell stack 10.

Since the exhaust hydrogen temperature T3 is lower than the temperature T2 of the piping of the circulation system of the hydrogen system, dew condensation in the circulation system can be prevented. Exhaust hydrogen containing droplets of the thermal T3 passes through the gas-liquid separator 43 and becomes a mixed gas of hydrogen and water vapor having a dew point T3, and thereafter, the piping of the circulation system is heated to T2, so that hydrogen can flow to the inlet of the fuel-cell stack 10 without condensation.

As shown in FIG. 3B, when the circulation system of the hydrogen system is installed in the upstream-side space 52, or when the circulation system is installed by being exposed to the outside air (≈T1) outside the case, the dew point T3 of the hydrogen gas in the circulation system is higher than the pipe-temperature T1 of the circulation system, and the hydrogen gas cools during the circulation and dew condensation is generated. Water buildup may occur in the piping of the circulation system, causing pressure loss to increase and freezing and clogging at low temperatures.

In the air-cooled fuel cell, since a large amount of cooling air is directly sucked into the fuel cell, at least the circulation system of the hydrogen system is provided in the space 53 on the downstream side of the cooling air, so that the generation of dew condensation in the circulation system of the hydrogen system is prevented, and by using hot air directly connected to the fuel cell, it is possible to take measures compactly without an additional device.

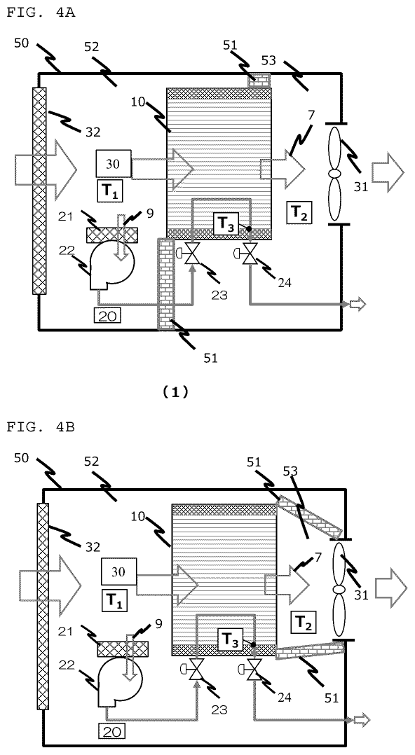

FIG. 4A is a system configuration diagram showing another example of the fuel cell system of the present disclosure; and FIG. 4B is a system configuration diagram showing another example of a conventional fuel cell system.

The fuel cell system shown in FIG. 4A and FIG. 4B include a case 50, a fuel cell stack 10, a reaction air system 20, a cooling air system 30, and a hydrogen system 40. In FIG. 4A and FIG. 4B, the description of the hydrogen system 40 is omitted for convenience. The reaction air system 20 includes a reaction air intake port 21, an air blower 22, an inlet-side sealing valve 23, and an outlet-side sealing valve 24. The cooling air system 30 includes a cooling fan 31 and an intake port 32. The intake port 32 may include an intake filter. The fuel cell system shown in FIG. 4A and FIG. 4B include sealing valves 23 and 24 at the entrance and exit of the reaction air system 20, and independent blowing device 22 and 31 for the reaction air system 20 and the cooling air system 30. The reaction air inlet 21 may include an air filter.

The fuel cell stack 10 has a flow path structure in which the reaction air and the cooling air are independent from each other.

The case 50 has an upstream space 52 and a downstream space 53 partitioned by the partition walls 51 in the flow direction of the cooling air 7 in the case 50 with respect to the fuel cell stack 10. The upstream space 52 is a space partitioned from the intake port 32 to the fuel cell stack 10, and the downstream space 53 is a space partitioned from the fuel cell stack 10 to the cooling fan 31.

In the fuel cell system shown in FIG. 4A, the inlet-side sealing valve 23, the outlet-side sealing valve 24, and the pipes of the reaction air system 20 are accommodated in the downstream-side space 53 of the cooling air.

As a result, the reactant air outlet temperature T3 of the fuel cell stack 10 is lower than the coolant air outlet average temperature T2 of the fuel cell stack 10.

Note that the air blower 22 and the inlet-side sealing valve 23 may be in either space because liquid water does not adhere thereto.

As shown in FIG. 4B, when the outlet-side sealing valve 24 of the reaction air system 20 is installed in the upstream-side space 52 or is installed by being exposed to the outside air (˜T1) outside the case, the dew point T3 of the reaction air in the reaction air system is higher than the piping temperature T1 of the reaction air system, and the reaction air cools to generate dew condensation. Water buildup may occur in the middle of piping of the reaction air system, causing pressure loss to increase and freezing and clogging at low temperatures.

### REFERENCE SIGNS LIST

1. Unit cell
2. Cooling fin (cooling air flow path)
3. Reaction air inlet
4. Reaction air outlet
5. Hydrogen gas inlet
6. Hydrogen gas outlet
7. Cooling air (cooling gas)
8. Hydrogen gas
9. Reaction air
10. Fuel cell stack
11. Separator
12. MEA and plastic frames
13. Current collector
14. Pressure plate
20. Reactive air system
21. Reaction air inlet
22. Air blower
23. Inlet side sealing valve
24. Outlet side sealing valve
30. Cooling air system
31. Cooling fan
32. Air inlet
40. Hydrogen system
41. Hydrogen tank
42. Hydrogen inlet valve
43. Gas separator
44. Hydrogen purge valve
45. Hydrogen pump
50. Case
51. Bulkhead
52. Upstream space
53. Downstream space

1. An air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the hydrogen system comprises a circulation system for circulating the hydrogen supplied to the fuel cell;
wherein the fuel cell system comprises a case;
wherein the case houses the fuel cell;
wherein the case includes, with respect to the fuel cell, an upstream space and a downstream space in the flow direction of the cooling air in the case; and
wherein the circulation system of the hydrogen system is disposed in the downstream space.

2. An air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the hydrogen system comprises a hydrogen purge valve at an outlet for the hydrogen of the fuel cell;
wherein the fuel cell system comprises a case;
wherein the case houses the fuel cell;
wherein the case includes, with respect to the fuel cell, an upstream space and a downstream space in the flow direction of the cooling air in the case; and
wherein the hydrogen purge valve of the hydrogen system is disposed in the downstream space.

3. An air-cooled fuel cell system,
wherein the fuel cell system comprises a fuel cell, a hydrogen system for supplying hydrogen to the fuel cell, a reaction air system for supplying reaction air to the fuel cell, and a cooling air system for supplying cooling air to the fuel cell;
wherein the fuel cell comprises a reaction air flow path and a cooling air flow path and has a flow path structure in which the reaction air and the cooling air are independent;
wherein the reaction air system comprises an inlet-side sealing valve at an inlet for the reaction air of the fuel cell and an outlet-side sealing valve at an outlet for the reaction air of the fuel cell;
wherein the fuel cell system comprises a case;
wherein the case houses the fuel cell;
wherein the case includes, with respect to the fuel cell, an upstream space and a downstream space in the flow direction of the cooling air in the case; and
wherein at least the outlet-side sealing valve of the reaction air system is disposed in the downstream space.

4. The fuel cell system according to claim 1,
wherein the hydrogen system comprises the circulation system and a hydrogen purge valve at an outlet for the hydrogen of the fuel cell, and
wherein the circulation system and hydrogen purge valve of the hydrogen system are disposed in the downstream space.

5. The fuel cell system according to claim 1,
wherein the hydrogen system comprises the circulation system and a hydrogen purge valve at an outlet for the hydrogen of the fuel cell;
wherein the reaction air system comprises an inlet-side sealing valve at an inlet for the reaction air of the fuel cell and an outlet-side sealing valve at an outlet for the reaction air of the fuel cell; and
wherein the circulation system of the hydrogen system, the hydrogen purge valve thereof, and at least the outlet-side sealing valve of the reaction air system are disposed in the downstream space.

6. The fuel cell system according to claim 1,
wherein the fuel cell comprises at least one of unit cell,
wherein the unit cell comprises an anode separator, a power generation unit, and a cathode separator, in this order,
wherein the cathode separator comprises the reaction air flow path on the side of the power generation unit, and comprises the cooling air flow path on the side opposite to the power generation unit.

7. The fuel cell system according to claim 6,
wherein the unit cell comprises a corrugated cooling fin as the cooling air flow path.
